(19) United States
(12) Patent Application Publication
(10) Pub. No.: US 2009/0020479 A1
(43) Pub. Date: Jan. 22, 2009

(54) Device and method for treatment of waste products including feces

(75) Inventor: Marc Jussen, Aachen (DE)

Correspondence Address: DOBRUSIN & THENNISCH PC, 29 W LAWRENCE ST, SUITE 210, PONTIAC, MI, 48342, US

(73) Assignee: GVS Gesellschaft fur Verwertungssysteme GmbH, Koln (DE)

(21) Appl. No.: 11/780,098

(22) Filed: Jul. 19, 2007

(51) Int. Cl. C02F 1/24; B01D 37/03

(52) U.S. Cl. 210/706; 210/173; 210/748; 210/202

(57) ABSTRACT

A device for treatment of solids and liquid waste comprising a storage container a comminution unit at least one separation unit, and an electroflotation unit.

The present invention relates to a device for treatment of human feces and sanitary solutions.

Toilet cabins are nowadays being set up in increasing numbers on building sites and at events. These toilet cabins are filled with ca. 60 liters of sanitary solution based on waste water and, for example, preferably natural essential oils stored in a capsule in the water, for example, or mixed with the waste water. When so required, the toilet cabins are emptied, disinfected, and filled with new sanitary solution. The fecal sludge, which is composed of human feces and of the sanitary solution, is pumped into a tank on board a truck and then has to be disposed of.

Since the above-described human feces and the sanitary solutions cannot readily be disposed of in a public sewage treatment plant, the object of the present invention was to make available a device for treatment of human feces and of the sanitary solution.

The object is achieved by a device for treatment of human feces and of the sanitary solution with an electroflotation unit.

It was a complete surprise, and could not be expected by a person skilled in the art, that it is possible, with the device according to the invention, to generate waste water that can be led off into the sewage system without additional authorization or can be forwarded for further use. The device according to the invention is simple to construct and to operate. The solids from the feces are separated and can be forwarded as useful material for heating purposes. The level of harmful substances in the fecal sludge is reduced considerably.

The device according to the invention takes up little space and has a very flexible capacity.

According to the invention, the device comprises an electroflotation unit.

Electroflotation is an alternative method to previously employed conventional precipitation and treatment methods in processing of waste water and of solid waste and is operated by current. It is based on a combination of electrolytic, chemical and physical processes in which flat material made of iron or aluminum is used as anode/cathode.

By means of electroflotation, water is removed from the solids of the feces, such that a relatively dry and solid residue remains, which can be used as fuel. In addition, heavy metals and other substances relevant to COD/BOD are at least partially oxidized. This procedure ensures inexpensive reduction of the amount of waste and a decrease in the level of harmful substances.

The only consumables needed are steel or aluminum plates whose consumption, like the energy consumption, depends on the consistency of the feces and the connection polarity of the metal. It may be assumed, however, that on average ca. 10-20 g of aluminum and 7-15 g of iron are preferably degraded per m³ of fecal sludge. The energy demand is preferably 4-40 kW per m³.

In the reactor, iron and aluminum anodes are used which, when current is supplied, flocculate the contaminants by oxide formation. The electrode material of the two metal plates is, however, only of importance for the anode side (+ pole). The cathode side (− pole) can be made of any desired conductive material, and a stainless steel cathode is even possible. For electrolysis, a direct current is applied whose strength is dependent on the electrical conductivity of the solution, the spacing of the electrodes and the level of harmful substances in the solution.

The electroflotation is preferably carried out specifically with disintegration of metal. The aluminum or iron anodes serve as sacrificial anodes, i.e. they are consumables that are degraded by the electrolysis. Aluminum and iron thus pass as cations into the solution. For the present case, the following equations can be formulated:

Fe(grid)→Fead Al(grid)→Alad

Fead+m H₂O→[Fe₃+(H₂O)m]+3 e−

Alad+m H₂O→[Al₃+(H₂O)m]+3 e−

By the electrolytic effect between anode and cathode in the reactor, very fine gas bubbles form through H₂O separation.

H₂O+ΔE→H₂+½O₂

The oxygen that is released is very aggressive and oxidizes the contaminants present in the waste, in particular the heavy metals, extremely intensively. The COD and BOD values relevant to the environment are also lowered by the oxidative environment, and nitrification also takes place.
Lead: Pb₂⁺+½O₂→PbO
Cadmium: Cd₂⁺+½O₂→CdO
Chromium: 2 Cr³⁺+1½O₂→Cr₂O₃
Copper: Cu₂₊+½O₂→CuO
Nickel: Ni²⁺+½O₂→NiO
Mercury: Hg²⁺+½O₂→HgO
Zinc: Zn²⁺+½O₂→NzO

The released hydrogen has a reducing effect and causes denitrification of the nitrate.

Ammonia NH₃:
NH₃ autoprotolysis in water: 2NH₃⇄NH₄++NH²⁻
Nitrification: 1) 2NH₄₊+O₂→2NO₂⁻4H++2H₂O nitrite
   2) 2NO₂−+O₂→2NO₃⁻ nitrate

A sludge flotation of nitrite and ammonia causes the formation of gaseous nitrogen:
Sludge flotation: NO₂⁻+NH₄⁻→N_{2↑T +2 H}₂O
Nitrate NO₃:
Denitrification: 2NO₃+5H₂+2H+→N_{2↑}+6 H₂O

In addition to these simple redox reactions, complex compounds of the different metals preferably form.

Iron protolyzes in aqueous solution over several intermediate steps to aqueous iron hydroxide (Fe(OH)] and to iron (III) oxide (Fe₂O₃). These complex cations finally condense to much larger complex ions, which for instance have the composition FeO(OH)n and Fe₂O₃

.n H₂O. The complex ions can take up contaminants by adsorption and thus convert them to settleable flocs. Upon discharge of the iron ions by hydrolysis, the positive metal hydroxide particles lose their water solubility. The positive iron hydroxides and iron oxides attach by adsorption to particles and colloids.

A storage container for collecting the intermittently arriving feces and sanitary solutions is preferably arranged upstream of the electroflotation unit. This container particularly preferably has a sieve with which components of the feces, for example T-shirts, underwear, shreds of material and metal parts and other small parts, are filtered from the feces and sanitary solution mixture. The filter can also be arranged upstream of the container.

The feces and the sanitary solution are also preferably treated by a comminution device. This comminution device breaks up the feces and homogenizes the solution and disperses the solids in the solution. This method step preferably takes place with a macerator, for example from the company called Allweiler, Germany.

The feces and the sanitary solution also preferably undergo a first separation of solids and liquid. This separation is preferably carried out using a decanter centrifuge. However, other separation systems can also be used. If so required, a cationic polymer can be delivered to the separation unit.

The solids fraction obtained from the separation step is preferably collected in a filtration container and very particularly preferably delivered then to a heating installation with which heat and/or current can be generated.

To improve the dewatering properties of the fecal sludge, the latter is preferably conditioned, i.e. the binding forces between the solid and liquid components are reduced by the effect of chemical and physical processes. This preferably takes place by means of a cationic polymer. This polymer flocculates the small particles of solids present in the fecal sludge, such that these can then be separated off. The highly liquid concentration of the fecal waste demands the use of polyelectrolyte for flocculation and dewatering. The polyelectrolyte consumption is dependent on the polyelectrolyte product used and on the concentration of the feces.

The polymer solution is preferably produced from liquid polymer concentrate. A 0.4% strength solution is preferably used, such that 4 liters of concentrate are sufficient for 1 cubic meter of polymer solution. The rate of consumption of the solution is preferably ca. 5-10 liters per cubic meter of fecal sludge.

The liquid phase of this separation is pumped to the electroflotation reactors, where further flocculation processes take place. The flocs are preferably stabilized by a polymer before being separated in a separation unit, preferably a vacuum band filter. This vacuum filter system is preferably designed for maximum dewatering at a high throughput rate. The waste water issuing from the electroflotation unit is again reduced in the main parameters and is preferably forwarded for further processing. The flocs preferably pass via a pump particularly preferably likewise into the decanter centrifuge where they are further dried.

The waste water from the electroflotation is preferably filtered again through a filter, for example a paper band filter, before it flows through a preferably controllable pump to the waste water transfer site.

If disruptions occur in the operation, a return of the waste water into the storage container is preferably possible. In this way, the complete installation can be pumped empty, without water running into the sewage system.

If the entire starting material, and not just the aqueous phase, is to be delivered to the electroflotation processes, the decanter centrifuge can also be used after the electroflotation.

The microflocs formed by the electroflotation stage are preferably likewise separated. Because of the small amount of solids, no vacuum band filter is needed in this method step. A flow band filter, for example, is sufficient for the filtration.

Through this last method step, the water preferably reaches discharge quality.

The process water is clear and may be discharged or irrigated, the COD, BOD and nitrate values lie in indirect discharge quality. Biological and bacteriological examination shows that the coli bacteria in the fecal water can be eliminated by 85% and the investigated pathogens In the biological examination can be almost completely eliminated.

Moreover, many other contaminants are removed from the waste water by the electroflotation, but these could not be examined in detail because of the large number of parameters.

The solids from the paper band filter are, like the solids from the centrifuge, preferably collected in a sealed container and preferably forwarded for further thermal utilization.

A further subject matter of the present invention is a method for treatment of human feces and sanitary solutions which is carried out in an electroflotation unit.

The above disclosures concerning the device apply equally to the method according to the invention.

The feces are preferably homogenized before the electroflotation and dispersed and then separated off.

The solids from the filtration and/or the solids from the electroflotation are also preferably collected and combusted.

In another preferred embodiment, the liquid issuing from the electroflotation unit is filtered once again. This filtering is preferably done with a paper filter.

The liquid thus treated is preferably discharged into a waste water system, for example a municipal sewage treatment plant, or can be forwarded for further use, for example for irrigation.

According to the invention, the method according to the invention and the device according to the invention can be carried out not with human feces and sanitary solutions, but instead with liquid manure that originates, for example, from pigs, cows, hens, sheep or similar animals.

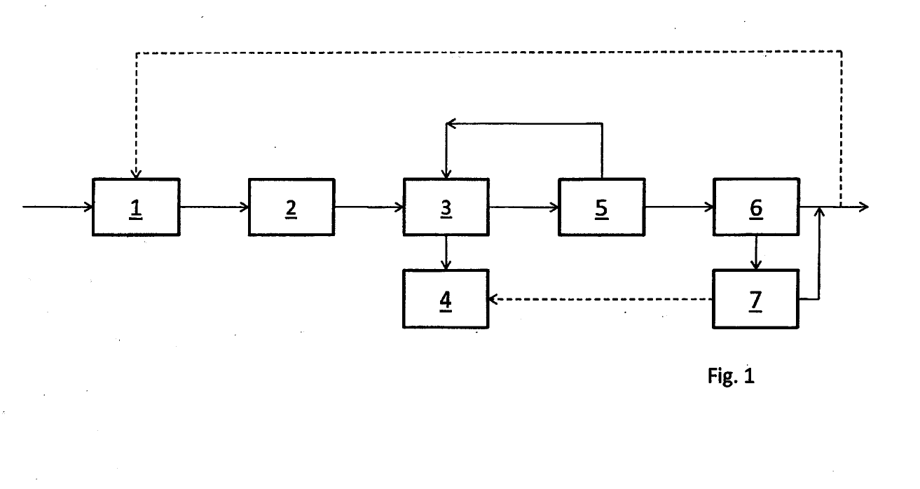

The invention is explained below with reference to the single FIG. 1. The explanations apply equally to the device according to the invention and to the method according to the invention.

FIG. 1 shows a chart of the method according to the invention and of the device according to the invention. First, the feces and the sanitary solution are collected in a storage container 1. Located in or upstream of the storage container there is a sieve with which solids that are not part of the feces or sanitary solution, for example T-shirts, underwear, shreds of material, metal parts or other parts, are filtered out of the solution. The feces and the sanitary solution, the fecal sludge are then transferred into a macerator in which the solids are reduced in size and the solution is homogenized and the solids in the solution are dispersed. The following method step is a solids separation 3, in the present case a decanter centrifuge which substantially separates the solids from the liquid. This separation can be assisted by a cationic polymer. The solids thus obtained are collected in a filtration container 4 and then forwarded, for example, for combustion. The liquid phase from the decanter centrifuge 3 passes into the electroflotation unit, where further flocculation processes and break-up of contaminants take place. The resulting flocs are preferably stabilized by a polymer before being dewatered. The process waste water arising from the electroflotation is reduced in the main parameters and is forwarded for further processing. The flocs pass through a pump likewise into the decanter centrifuge, where they are further dried.

If it is not just the aqueous phase but the entire starting material that is to be forwarded to the electroflotation process, the solids separation unit 3 can also be arranged downstream of the electroflotation unit. In the event of a disturbance occurring, the entire liquid located in units 2, 3, 5 and 6 can be pumped from the outflow back into the storage container. The plant can accordingly be emptied completely of liquid, without the latter having to be conveyed into the sewage system.

### EXAMPLE

In this example, the following method steps are used:

1. Separation of the Coarse Solids in the Waste from Toilet Cabins

Elimination of foreign matter such as T-shirts, underwear, metals, etc.

2. Comminution of the Material

Homogenization of the material

Comminution in order to make the material pumpable

3. Conditioning of the Fecal Sludge, Separation:

Removal of most of the solids, this can be used

Reduction of the TS in the fecal water

Reduction of N—NH₄ and PO₄, COD-BOD in the fecal sludge

Non-separable substances are flocculated and separated

4. Treatment of the Process Water by Means of Electroflotation:

Oxidation and flocculation processes reduce COD and N load

Treated fecal waste water reaches the required discharge values.

5. Separation of the Flocs:

Separation of the rest of the solids, collection and utilization of the material

The process water is clear and can be discharged or used for irrigation

The solids likewise pass into the container; the clean water is emptied into the sewage system or can be forwarded for further use.

Results:

The following table shows typical values:

| | | | | | | | Limit values | |
|---|---|---|---|---|---|---|---|---|
| | | | | | | | as per §4 | |
| | | | | | | | paragraphs 11 | |
| | Feces from | | | | Clear | | and 12 of the | |
| | toilet cabins | | Solids | | solution | | AbfKlarV | |
| COD | 25,500 | mg/l | 204 | mg/g | 468 | mg/l | | |
| BOD5 | 4,020 | mg/l | —.— | | 89 | mg/l | | |
| Ammonium N | 360 | mg/l | 210 | mg/kg | 87 | mg/l | | |
| Total P | 18.2 | mg/g mT | 18.7 | mg/g mT | 0.21 | mg/l | | |
| Lead Pb | 87 | mg/kg mT | 90 | mg/kg mT | <0.05 | mg/l | 900 | mg/kg mT |
| Cadmium Cd | 2.7 | mg/kg mT | 2.4 | mg/kg mT | <0.005 | mg/l | 10 | mg/kg mT |
| Chromium Cr | 21 | mg/kg mT | 19 | mg/kg mT | <0.05 | mg/l | 900 | mg/kg mT |
| Copper Cu | 190 | mg/kg mT | 170 | mg/kg mT | 0.11 | mg/l | 800 | mg/kg mT |
| Nickel Ni | 22 | mg/kg mT | 25 | mg/kg mT | <0.05 | mg/l | 200 | mg/kg mT |
| Mercury Hg | 0.87 | mg/kg mT | 081 | mg/kg mT | <0.001 | mg/l | 8 | mg/kg mT |
| Zinc | 760 | mg/kg mT | 810 | mg/kg mT | 0.27 | mg/l | 250 | mg/kg mT |

The process water is filtered again through a further paper filter before flowing through a controllable pump to the waste water transfer point.

### LIST OF REFERENCE NUMBERS

| | |
|---|---|
| 1 | storage container |
| 2 | unit for comminution of solids |
| 3 | solids separation unit |
| 4 | filtration container, combustion |
| 5 | electroflotation unit |
| 6 | solids separation unit |
| 7 | solids separation unit |

1-15. (canceled)

16. A device for treatment of waste products including feces a comminution unit for breaking of solids of the waste products and an electroflotation unit for removing liquid from the solids using a current.

17. The device of claim 16, further comprising a storage container configured for collecting intermittently arriving solid and liquid waste components and is arranged upstream of the electroflotation unit.

18. The device of claim 17, wherein the comminution unit breaks up solid component so that the solids are dispersed in the liquid component, thereby forming a generally homogenous waste solution, the comminution unit being arranged upstream of the electroflotation unit.

19. The device of claim 18, further comprising at least one separation unit for separating the liquid component from the solid component, the at least one separation unit includes a first solids separation unit configured for separating at least portion of the solid component from the waste solution, the first solids separation unit being arranged downstream of the comminution unit.

20. The device of claim 19, further comprising a filtration container in which the solid component are collected from the at least one separation unit.

21. The device of claim 19, wherein the at least one separation unit further includes a second solids separation unit, a third solids separation unit, or both that is arranged downstream of the electroflotation unit.

22. The device of claim 21, wherein the first solids separation unit is arranged upstream of the electroflotation unit and solid component, the liquid component, the waste solution, or any combination thereof exiting the electroflotation unit is delivered back to the first solids separation unit, delivered to the second solids separation unit, or both for additional separation of the solid component.

23. The device of claim 16, wherein at least a portion of the solid component, the liquid component, or both of the waste solution exiting the comminution unit, the at least one separation unit, the electroflotation unit, or any combination thereof is emptied back into the storage container.

24. The device of claim 16, wherein a cationic polymer is introduced to the waste solution for reducing the binding forces of the solid and liquid components of the waste solution.

25. The device of claim 16, wherein the solid and liquid waste is feces, a sanitary solution, liquid manure, or any combination thereof.

26. The device of claim 16, wherein the device comprises:
the storage container for collecting the intermittently arriving solid and liquid waste components and is arranged upstream of the electroflotation unit;
the comminution unit for breaking up the solid component so that the solids are dispersed in the liquid component, thereby forming a generally homogenous waste solution, the comminution unit being arranged upstream of the electroflotation unit;
the at least one separation unit including a first solids separation unit, the first solids separation unit configured for separating at least portion of the solid component from the waste solution, the first solids separation unit being arranged downstream of the comminution unit; and
the electroflotation unit for flocculating small particles of solids in the waste solution.

27. A method for treatment of waste products comprising the steps of:
providing:
a storage container for collecting the intermittently arriving solid and liquid wastes;
a comminution unit;
at least one separation unit including a first solids separation unit; and
an electroflotation unit;
breaking up waste solids so that the solids are dispersed in the liquid waste, thereby forming a generally homogenous waste solution in the comminution unit;
at least partially separating the solids from the waste solution in the first solids separation unit; and
flocculating small particles of solids in the waste solution in the electroflotation unit.

28. The method of claim 27, wherein the solid and liquid wastes are comminuted upstream of the electroflotation unit.

29. The method of claim 28, wherein the waste solution is separated in the first solids separation unit upstream of the electroflotation unit.

30. The method of claim 29, wherein the solids from the first solids separation unit, the solids arising in the electroflotation unit, or both are collected and combusted.

31. The method of claims 29, wherein the waste solution issuing from the electroflotation unit is filtered in a second solids separation unit.

32. The method of claim 29, wherein the waste solution from the electroflotation unit is discharged into a waste water system.

33. The method of claim 29, further comprising the step of reducing the binding forces of the solid and liquid components of the waste solution.

34. The method of claim 33, wherein the step of reducing is accomplished by introducing a cationic polymer to the waste solution.

35. The method of claim 27, wherein the solid and liquid wastes is feces, a sanitary solution, liquid manure, or any combination thereof.
